(19) United States
(12) Patent Application Publication
(10) Pub. No.: US 2021/0279605 A1
(43) Pub. Date: Sep. 9, 2021

(54) EFFICIENTLY GENERATING ACCURATE RESPONSES TO A MULTI-FACET QUESTION BY A QUESTION ANSWERING SYSTEM

(71) Applicant: INTERNATIONAL BUSINESS MACHINES CORPORATION, Armonk, NY (US)

(72) Inventors: KYLE M BRAKE, Westerville, OH (US); STEPHEN A. BOXWELL, FRANKLIN, OH (US); KEITH G. FROST, Delaware, OH (US); STANLEY J. VERNIER, GROVE CITY, OH (US)

(21) Appl. No.: 16/811,970

(22) Filed: Mar. 6, 2020

(51) Int. Cl. G06N 5/04; G06F 40/20

(52) U.S. Cl. CPC G06N 5/04; G06F 40/20

(57) ABSTRACT

A controller receives a multi-facet natural language question from a user at a question answering system and generates one or more inquiry questions to submit to the question answering system for an order type requirement of the multi-facet natural language question. The controller evaluates responses, each with a respective confidence score by the question answering system, to each of the one or more inquiry questions to identify a selection of answers from among the responses, the selection of answers capped at a number of specific answers assessed for the multi-facet natural language question. The controller merges the selection of answers into a single aggregated answer to return to the user in response to the multi-facet natural language question.

### BACKGROUND

### 1. Technical Field

One or more embodiments of the invention relate generally to data processing and particularly to efficiently generating accurate responses to a multi-facet question by a question answering system.

### 2. Description of the Related Art

Natural language processing (NLP) refers to a technique that supports applications that facilitate human interaction in natural language with machines. For example, one branch of NLP pertains to answering questions about a subject matter based on information available about the subject matter from a large corpus, or collection of data, such as text, stored electronically.

### BRIEF SUMMARY

In one embodiment, a method is directed to, responsive to receiving a multi-facet natural language question from a user at a question answering system, generating, by a computer, one or more inquiry questions to submit to the question answering system for an order type requirement of the multi-facet natural language question. The method is directed to evaluating, by the computer, a plurality of responses, each with a respective confidence score by the question answering system, to each of the one or more inquiry questions to identify a selection of answers from among the plurality of responses, the selection of answers capped at a number of specific answers assessed for the multi-facet natural language question. The method is directed to merging, by the computer, the selection of answers into a single aggregated answer to return to the user in response to the multi-facet natural language question.

In another embodiment, a computer system comprises one or more processors, one or more computer-readable memories, one or more computer-readable storage devices, and program instructions, stored on at least one of the one or more storage devices for execution by at least one of the one or more processors via at least one of the one or more memories. The stored program instructions comprise program instructions, responsive to receiving a multi-facet natural language question from a user at a question answering system, to generate one or more inquiry questions to submit to the question answering system for an order type requirement of the multi-facet natural language question. The stored program instructions comprise program instructions to evaluate a plurality of responses, each with a respective confidence score by the question answering system, to each of the one or more inquiry questions to identify a selection of answers from among the plurality of responses, the selection of answers capped at a number of specific answers assessed for the multi-facet natural language question. The stored program instructions comprise program instructions to merge the selection of answers into a single aggregated answer to return to the user in response to the multi-facet natural language question.

In another embodiment, a computer program product comprises a computer readable storage medium having program instructions embodied therewith, wherein the computer readable storage medium is not a transitory signal per se. The program instructions executable by a computer to cause the computer to, responsive to receiving a multi-facet natural language question from a user at a question answering system, generate, by a computer, one or more inquiry questions to submit to the question answering system for an order type requirement of the multi-facet natural language question. The program instructions executable by a computer to cause the computer to evaluate, by the computer, a plurality of responses, each with a respective confidence score by the question answering system, to each of the one or more inquiry questions to identify a selection of answers from among the plurality of responses, the selection of answers capped at a number of specific answers assessed for the multi-facet natural language question. The program instructions executable by a computer to cause the computer to merge, by the computer, the selection of answers into a single aggregated answer to return to the user in response to the multi-facet natural language question.

### BRIEF DESCRIPTION OF THE SEVERAL VIEWS OF THE DRAWINGS

The novel features believed characteristic of one or more embodiments of the invention are set forth in the appended claims. The one or more embodiments of the invention itself however, will best be understood by reference to the following detailed description of an illustrative embodiment when read in conjunction with the accompanying drawings, wherein:

FIG. 1 illustrates one example of a block diagram of a natural language processing (NLP) answering system for efficiently generating accurate responses to a multi-facet question;

FIG. 2 illustrates one example of a block diagram of components of a multi-facet controller for an NLP question answering system;

FIG. 3 illustrates one example of a block diagram of an efficient, accurate response generated to a multi-facet question requesting an unordered list by a question answering system;

FIG. 4 illustrates one example of a block diagram of an efficient, accurate response generated to a multi-facet question requesting an ordered list by a question answering system;

FIG. 5 illustrates one example of a block diagram of a response generated to a multi-facet question requesting an ordered list, with an alert that the ordered list cannot be determined;

FIG. 6 illustrates one example of a computer system in which one embodiment of the invention may be implemented;

FIG. 7 illustrates a high-level logic flowchart of a process and computer program for evaluating multi-facet questions and efficiently generating accurate responses to multi-facet questions by a question answering system;

FIG. 8 illustrates a high-level logic flowchart of a process and computer program for efficiently generating accurate responses to a multi-facet question requesting an unordered list from a question answering system;

FIG. 9 illustrates a high-level logic flowchart of a process and computer program for efficiently generating accurate responses to a multi-facet question requesting an ordered list from a question answering system; and

FIG. 10 illustrates a high-level logic flowchart of a process and computer program for identifying a particular selection of responses to a multi-facet question requesting an ordered list by a question answering system.

### DETAILED DESCRIPTION

In the following description, for the purposes of explanation, numerous specific details are set forth in order to provide a thorough understanding of the present invention. It will be apparent, however, to one skilled in the art that the present invention may be practiced without these specific details. In other instances, well-known structures and devices are shown in block diagram form in order to avoid unnecessarily obscuring the present invention.

In addition, in the following description, for purposes of explanation, numerous systems are described. It is important to note, and it will be apparent to one skilled in the art, that the present invention may execute in a variety of systems, including a variety of computer systems and electronic devices operating any number of different types of operating systems.

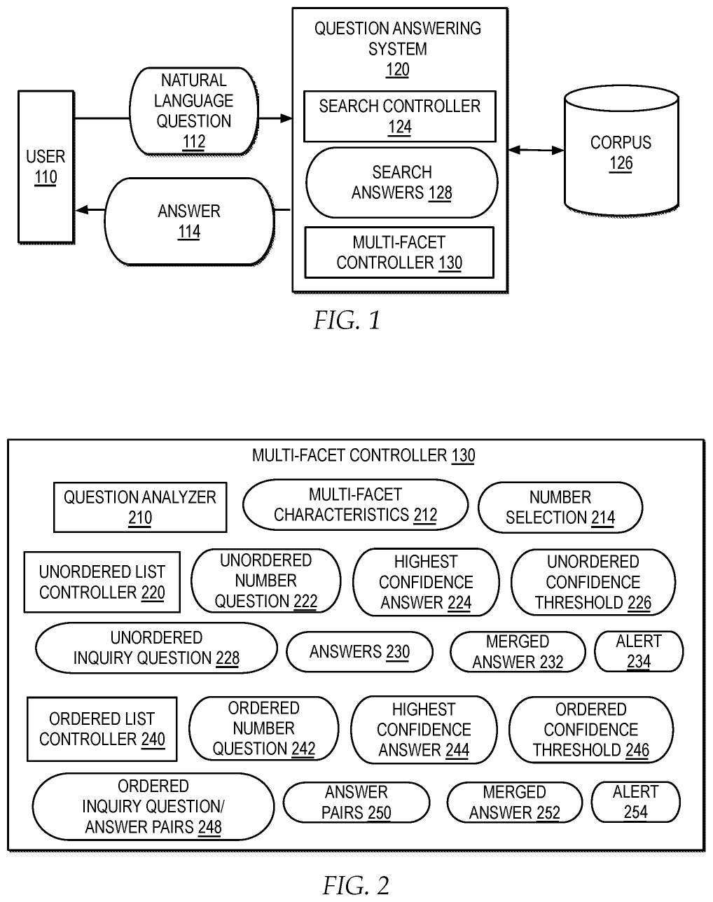

FIG. 1 illustrates one example of a block diagram of a natural language processing (NLP) answering system for efficiently generating accurate responses to a multi-facet question.

In one example, FIG. 1 illustrates a user 110 submitting a natural language question 112 to a question answering system 120. In one example, question answering system 120 represents a cognitive computing system that supports answering natural language question 112 through NLP techniques that facilitate the exchange of information with users who submit questions in a natural language. In one example, user 110 includes one or more of a human and an automated user.

In one example, natural language question 112 includes a string of text, which forms the basis of the elements of a query. In one example, natural language question 112 includes a string of text in a sentence structure associated with a question. In another example, natural language question 112 includes a string of text with elements that effectively present a question. In one example, the string of text in natural language question 112 represents a string of text elements in a natural human language format.

In the example illustrated, question answering system 120 provides an automated mechanism that supports NLP based answering of questions about a subject matter based on information available in a corpus 126, including a volume of passages of data. For example, question answering system 120 supports searching through large sets of sources of content in corpus 126 and analyzing the passages with regard to natural language question 112 to determine an answer to the question and a confidence measure as to how accurate an answer to the question may be.

In one example, machine learning plays a central role in artificial intelligence-based applications that interact with one or more NLP systems, such as question answering system 120. One of the primary outcomes of the process of creating and training a machine learning environment is a data object, referred to as a model, built from sample inputs. In one example, the one or more models in question answering system 120 each represent a data object of a machine learning environment. According an advantage of the present invention, a data object in a machine learning environment provides automated natural language processing and text classification analysis of volumes of text in corpus 126 that are so large, such as millions of words and phrases, that a person attempting to analyze the same volumes of text would require years of work to reach a same conclusion that machine learning based data objects are capable of performing in increments of a second or less, and likely with a greater accuracy than could be performed by a person having to process the same volume of information.

For example, corpus 126 represents data, or a collection of data, used in linguistics and language progressing. In general, corpus 126 includes large volumes of data stored electronically. For example, corpus 126 may represent a collection of machine-readable texts that are representative of a variety of language, such as, but not limited to, newspaper articles, blogs, books, text of spoken speech, text from social media entries, and legal documents. In addition, each of natural language question 112 and corpus 126 may include structured and unstructured data. In one example, question answering system 120 converts unstructured data in one or more of natural language question 112 and corpus 126 into structured data, through pre-defined data models or schema, with annotations and metadata that assist in identifying patterns and inferences. For example, question answering system 120 may convert corpus 126 from unstructured data into structured data stored within a structure, such as a relational database, identified by searchable, predefined data models or schema, or other structures including annotations identified using a same specification. In one example, question answering system 120 may apply one or more classifiers for annotating one or more of natural language question 112 and corpus 126.

In particular, in the example, question answering system 120 includes a search controller 124 that receives natural language question 112, searches corpus 126 or one or more models already created from corpus 126, selects one or more passages relevant to a natural language question 112, and generates one or more answers based on the selected passages, illustrated by search answers 128. In one example, each of the answers in search answers 128 may include a separate confidence score, indicating a probability that the answer is relevant to natural language question 112. In additional or alternate embodiments, search controller 124 may manage one or more additional or alternate types of searches of a question and answer pipeline of data and models to generate search answers 128.

In one example, natural language question 112 may include questions that when answered most accurately, may include a single answer or multi-faceted answers. In addition, natural language question 112 may include questions, referred to as multi-faceted questions, that when answered most accurately may include a multi-faceted answer with an order type, such as an unordered list or an ordered list, each including multiple responses in a single answer. For example, natural language question 112 may include a multi-faceted question that requests an answer that includes multiple features of a domain which are not sequentially classified, such as an unordered list. In another example, natural language question 112 may include a multi-faceted question that requests an answer that includes multiple features of a domain which are sequentially classified, such as an ordered list. In one example, a domain may represent a topic and features may represent subtopics, nuances, parts, or other elements of a topic.

For example, a multi-facet question requesting an answer that includes multiple features of a domain that are not sequentially classified may include a question that follows a format of “What X are part of Y”, such as “What are the food groups?” or “What are the branches of government?”, where the answers are not limited to a particular sequence. In another example, a multi-facet question requesting an answer that includes multiple features of a domain that are sequentially classified may include a question such as “What are the Ys of X?” with Y indicating an order classification, such as “What are the stages of grief?” or “What are the steps to take when something is on fire?”, where the sequence of the answers is relevant.

According to an advantage of the present invention, question answering system 120 applies a multi-facet controller 130 to natural language question 112 to evaluate whether natural language question 112 is a multi-facet type of question that requests a multi-facet answer. If multi-facet controller 130 detects that natural language question 112 is a multi-facet type of question that requests a multi-facet answer, then multi-facet controller 130 determines an order type of the question, manages the formatting of one or more questions submitted to search controller 124 for the order type, and manages the selection of responses from search answers 128 for the order type, to return in answers 114 to efficiently generate an accurate multi-facet answer to multi-facet questions. According to an advantage of the invention, by managing multi-facet questions through multi-facet controller 130 to manage formatting of the one or more questions submitted and selection of responses to return in answers 114, question answering system 120 not only improves the accuracy of the number of passages and selection of passages returned to user 110 in answer 114, but also improves the confidence that user 110 may have in the answer when answer 114 is returned with a list that matches an expected multi-faceted format to the type of multi-facet question.

In addition, according to an advantage of the present invention, multi-facet controller 130 supports efficiently generating accurate answers to multi-facet questions independent of whether or not corpus 130 may include one or more entries with an explicit list that may answer a multi-facet question. For example, for a multi-facet type question of “what are the Xs of Y?”, corpus 130 may include an explicit list of the Xs of Y for one type of X and Y, but may not include an explicit list of the Xs of Y for another type of X and Y, such that multi-facet controller 130 supports generating an accurate multi-facet answer to a multi-facet question independent of whether corpus 130 includes an explicit list that answers the multi-facet question.

Further, according to an advantage of the present invention, multi-facet controller 130 supports efficiently generating accurate responses to multi-facet questions independent of whether or not the user enters a specific number of expected responses in natural language question 112. For example, if one user enters a multi-facet question of “what are the N steps of Y?”, where N indicates a number of expected responses of a number of steps, and other user enters a multi-facet question of “what are the steps of Y”, but does not enter a number N indicating an expected number of steps, multi-facet controller 130 supports generating an accurate response to multi-facet questions independent of whether the user indicates a specific number of expected responses to the multi-facet question.

FIG. 2 illustrates one example of a block diagram of components of a multi-facet controller for an NLP question answering system.

In one example, in response to NLP question answering system 120 receiving natural language question 112, a question analyzer 210 of multi-facet controller 130 analyzes natural language question 112 to identify whether the question is a multi-facet question. In the example, multi-facet controller 130 may evaluate that the question is a multi-facet question by testing whether the question includes one or more characteristics from multi-facet characteristics 212. In one example, multi-facet characteristics 212 may include one or more types of information or formats of information that are associated with a multi-facet question that is classified as a request for an unordered list or an ordered list. In one example, multi-facet characteristics 212 may represent one or more types of classifiers that evaluate the focus and other attributes of request to determine whether the requests is a question that asks for multiple features of a domain and to determine if the questions asks for an unordered or ordered list of information.

In one example, if question analyzer 210 identifies that natural language question 112 is a multi-facet question, then question analyzer 210 also identifies whether the multi-facet question specifies a selected number of answers in the request. In one example, if question analyzer 210 identifies the multi-facet question does specify a selected number of answers in the request, then question analyzer 210 sets number selection 214 with the selected number of answers setting for a value of N. In one example, if question analyzer 210 does not identify that the multi-facet question specifies a selected number of answers in the request, then question analyzer 210 triggers a controller for the type of multi-facet question, with number selection 214 initially set to null.

In one example, question analyzer 210 triggers unordered list controller 220 for a multi-facet question that requests a response that includes multiple answers that are not sequentially classified. In one example, unordered list controller 220 initially determines whether number selection 214 is set. If number selection 214 is not yet set, then unordered list controller 220 generates an unordered number question 222 that requests a number of answers expected for the multi-facet question, such as requesting a number of expected subcategories of a category, and submits unordered number question 222 to NLP search controller 124 for evaluation by a question/answer (QA pipeline) of NLP search controller 124 that may include one or more types of classifiers. For example, for a question submitted in a format of “What X are part of Y?”, unordered number question 222 may follow a format such as “How many Xs are part of Y?”. Unordered list controller 220 evaluates the responses received in search answers 128 for unordered number question 222 and identifies a number within the response with a confidence as a highest confidence answer 224. In the example, if the confidence of highest confidence answer 224 is greater than an unordered confidence threshold 226, then unordered list controller 220 sets number selection 214 to the number in highest confidence answer 224, otherwise unordered list controller 220 sets number selection 214 to “all”.

In the example, once unordered list controller 220 detects that number selection 214 is not set to “null”, unordered list controller 220 generates an unordered inquiry question 228 that requests answers to the multi-facet question, such as requesting subcategories of a category, and submits unordered inquiry question 228 to NLP search controller 124 for evaluation by the QA pipeline. For example, for a question submitted in a format of “What X are part of Y?”, unordered inquiry question 228 may follow a format such as “What Xs are part of Y?” In the example, unordered list controller 220 collects and evaluates the responses received in search answers 128, each with a confidence score, as answers 230. In the example, if number selection 214 is set to a number, then unordered list controller 220 merges the top N responses from answers 226 into a single aggregate answer, ordered by confidence score, as illustrated by merged answer 232, and returns the single aggregate answer in answer 114. Otherwise, in the example, if number selection 214 is set to “all”, then unordered list controller 220 returns answer 114 with the full list of responses in answers 230 and with an alert 234 that the number of items to list could not be determined.

In one example, question analyzer 210 triggers ordered list controller 240 for a multi-facet question that requests a response of sequentially classified answers in an ordered list. In one example, ordered list controller 240 initially determines whether number selection 214 is set. If number selection 214 is not yet set, then ordered list controller 240 generates an ordered number question 242 that requests a number of answers expected for the multi-facet question, such as requesting an amount of expected subcategories of a category or a number of expected features of a domain, and submits ordered number question 242 to NLP search controller 124 for evaluation by the QA pipeline. For example, for a question submitted in a format of “What are the Ys of X?”, ordered number question 242 may follow a format such as “How many Ys are in X?”. Ordered list controller 240 evaluates the responses in search answers 128 received for ordered number question 242 and identifies a number within the answer with a confidence as a highest confidence answer 244. In the example, if the confidence of highest confidence answer 244 is greater than an ordered confidence threshold 246, then ordered list controller 240 sets number selection 214 to the number in highest confidence answer 244, otherwise ordered list controller 240 sets number selection 214 to “all”.

In the example, once ordered list controller 240 detects that number selection 214 is not set to “null”, ordered list controller 240 generates ordered inquiry question/answer pairs 248 that each request answers to an iteration of the multi-facet question, such as requesting subcategories of a category, and recursively submits each question in ordered inquiry question/answer pairs 248 to NLP search controller 124 for evaluation by the QA pipeline for each entry in a sequentially classified question. For example, for a question submitted in a format of “What are the Ys of X?”, question entries in ordered inquiry question/answer pairs 248 may follow a format of recursively searching a question in a format such as “What is the Ith Y of X?”, where I is incremented in each iteration. In the example, ordered list controller 240 collects and evaluates the responses received in search answers 128, each paired with a confidence score, in an array of question to answer/confidence pairs in answer pairs 250. Ordered list controller 240 removes responses from answer pairs 250 that do not exceed ordered confidence threshold 246. Ordered list controller 240 evaluates, for each entry in answer pairs 250, whether to add an only or top scored response from answer pairs 250 as the answer in each pair in ordered inquiry question/pairs 248. If ordered list controller 240 adds a separate answer to each pair in ordered inquiry question/pairs 248 without detecting any errors, ordered list controller 240 merges the ordered answer entries from ordered inquiry question/pairs 248 into a merged answer 252, and returns merged answer 252 in answer 114 as an ordered list. In one example, order list controller 240 may also evaluate that an entry in answer pairs 250 does not include any answers or that a redundant answer would be added to ordered inquiry question/pairs 248 and returns answer 114 with the responses in answers pairs 250 and with an alert 254 that an ordered list could not be determined.

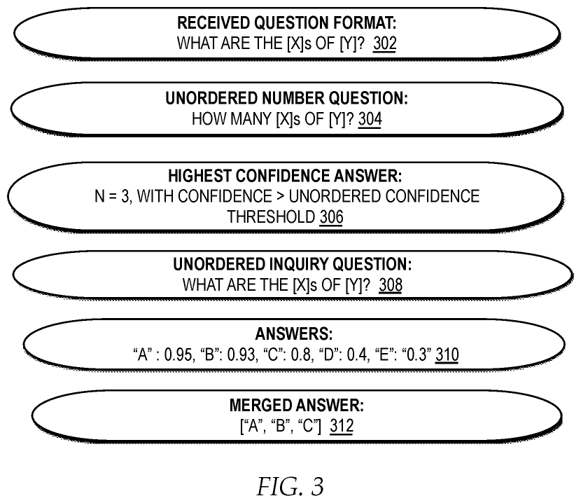

FIG. 3 illustrates a block diagram of an example of an efficient, accurate response generated to a multi-facet question requesting an unordered list by a question answering system.

In the example, question analyzer 210 identifies that a received question is in a multi-facet unordered format, such as a question in a format illustrated at reference numeral 302 of “what are the [X]s of [Y]?”, where X is a request for any number of answers, unordered, falling under a category of “X” that are associated with a larger domain of “Y”. For example, a question such as “What are the branches of government?” includes “branches” as “X” and “government” as “Y”.

In the example, the received question illustrated at reference numeral 302 does not specify a number of answers requested, therefore unordered list controller 220 first generates an unordered number question in the format illustrated at reference numeral 304 of “how many [X]s of [Y]?” and submits the question to NLP search controller 124. For example, the question of “What are the branches of government?” may be formatted into an unordered number question of “How many branches of government?”

In the example, NLP search controller 124 returns responses that indicate the number of “X”s of “Y”, each with a confidence value. As illustrated at reference numeral 306, unordered list controller 220 selects a number from the responses based on the highest confidence value in the responses returned in search answers 128 that is greater than unordered confidence threshold 226 and sets N in number selection 214 to “3”.

In the example, unordered list controller 220 next generates and submits an unordered inquiry question to search controller 124 in the format illustrated at reference numeral 308 of “what are the [X]s of [Y]?”. In the example, the returned responses in search answers 128, illustrated at reference numeral 310, include five answers of “A” with confidence score “0.95”, “B” with confidence score “0.93”, “C” with confidence score “0.8”, “D” with confidence score “0.4”, and “E” with confidence score “0.3”. For example, for a question of “what are the branches of government?”, answers may include “executive” with a confidence score of “0.95”, “judicial” with confidence score “0.93”, “legislative” with confidence score “0.8”, “parliament” with confidence score “0.4”, and “king” with confidence score “0.3”.

As illustrated at reference numeral 312, in the example, unordered list controller 220 next selects the top N scored entries in the answers and merges the entries into a single unordered list in a merged answer of [“A”, “B”, “C”]. For example, for the answers of “executive” with a confidence score of “0.95”, “judicial” with confidence score “0.93”, “legislative” with confidence score “0.8”, “parliament” with confidence score “0.4”, unordered list controller 220 may merge the top 3 answers into a merged answer of [“executive”, “judicial”, “legislative”]. In the example, while there are different governmental structures, and some governments with “branches” may have more or less than 3, unordered list controller 220 selects a number of responses with the highest confidence level and selects the responses with the highest confidence level for the number of responses, to efficiently generate a high confidence, aggregated answer of a list of responses to a multi-facet question.

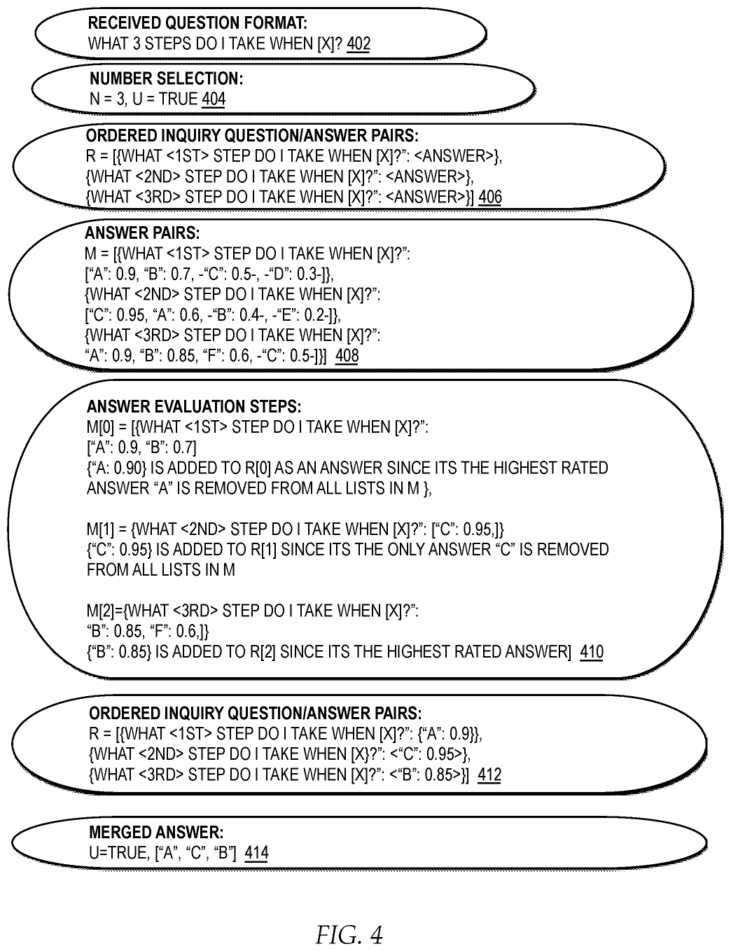

FIG. 4 illustrates a block diagram of an example of an efficient, accurate response generated to a multi-facet question requesting an ordered list by a question answering system.

In the example, question analyzer 210 identifies that a received question is in a multi-facet ordered format, such as a question in a format illustrated at reference numeral 402 of “what 3 steps do I take when [X]?”, where “Y” is the “steps” and “X” is a domain of information. In the example, “steps” is evaluated as an indicator of an ordered list request. For example, the ordered list question may specify “what 3 steps do I taken when there is a fire?”.

In the example, as illustrated at reference numeral 404, the received question specifies a number of answers requested by specifying “3 steps”, therefore ordered list controller 240 sets “N” to 3, and a variable “U” to true, since the selected number is set for the ordered list request. In the example, as illustrated at reference numeral 406, ordered list controller 240 sets an “R” ordered inquiry question/answer pairs 248 with an array of “N” questions/answer pairs, with each question set to an iteration of a question, and an entry space for an answer pair. For example, as illustrated at reference numeral 406, the original question of “what 3 steps do I take when [X]?” is added to ordered inquiry question/answer pairs 248 as a first question “What <1st> step do I take when [X]?”, a second question “What <2nd> step do I take when [X]?”, and a third question “What <3rd> step do I take when [X]?”

In the example, as illustrated at reference numeral 408, ordered list controller 240 separately sends each of the questions in ordered inquiry question/answer pairs 248 to search controller 124 and collects the responses separately received in search answers 128 for each question into a separate entry in “M” answer pairs 250. In the example, for the first question entry, answer pairs 250 includes responses, paired with confidence scores of a first question paired with an answer of [“A”: 0.9, “B”: 0.7, −“C”: 0.5−, −“D”: 0.3−], a second question paired with an answer of [“C”: 0.95, “A”: 0.6, −“B”: 0.4−, −“E”: 0.2−], and a third question paired with an answer of [“A”: 0.9, “B”: 0.85, “F”: 0.6, −“C”: 0.5−]. In the example, ordered list controller 240 applies ordered confidence threshold 246 set to “0.5” and marks all entries that are not greater than “0.5” with negative marks to indicate the entry is removed.

In the example, as illustrated at reference numeral 410, ordered list controller 240 evaluates each answer pair entry in “M” answer pairs 250 and determines which response to include in “R” ordered inquiry question/answer pairs 248. As illustrated at reference numeral 410, for the first entry in “M[0]”, the available responses in the answer are [“A”: 0.9, “B”: 0.7] and ordered list controller 240 selects the top scored answer of [“A”: 0.9] to add to entry “R[0]” of ordered inquiry question/answer pairs 248 as an answer, and removes “A” from all other lists in “M”, since “A” is already selected as an answer. Next, as illustrated at reference numeral 410, for the second entry in “M[1]”, the available responses in the answer are [“C”: 0.95] and ordered list controller 240 selects the only scored answer of [“C”: 0.95] to add to entry “R[1]” of ordered inquiry question/answer pairs 248 as an answer, and removes “C” from all other lists in “M”, since “C” is already selected as an answer. Next, as illustrated at reference numeral 410, for the third entry in “M[2]”, the available responses in the answer are [“B”:0.85, “F”:0.6] and ordered list controller 240 selects the top scored answer of [“B”:0.85] to add to entry “R[2]” of ordered inquiry question/answer pairs 248 as an answer.

In the example, as illustrated at reference numeral 412, the answer entries of ordered inquiry question/answer pairs 248 are each updated to include a separate, non-redundant answer, and nothing has set a variable U to false. In the example, as illustrated at reference numeral 414, ordered list controller 240 merges the answers in ordered inquiry question/answer pairs 248 into an ordered list in merged answer 252 of [“A”, “C”, “B”], corresponding with the ordering of the answers in the ordered entries of ordered inquiry question/answer pairs 248.

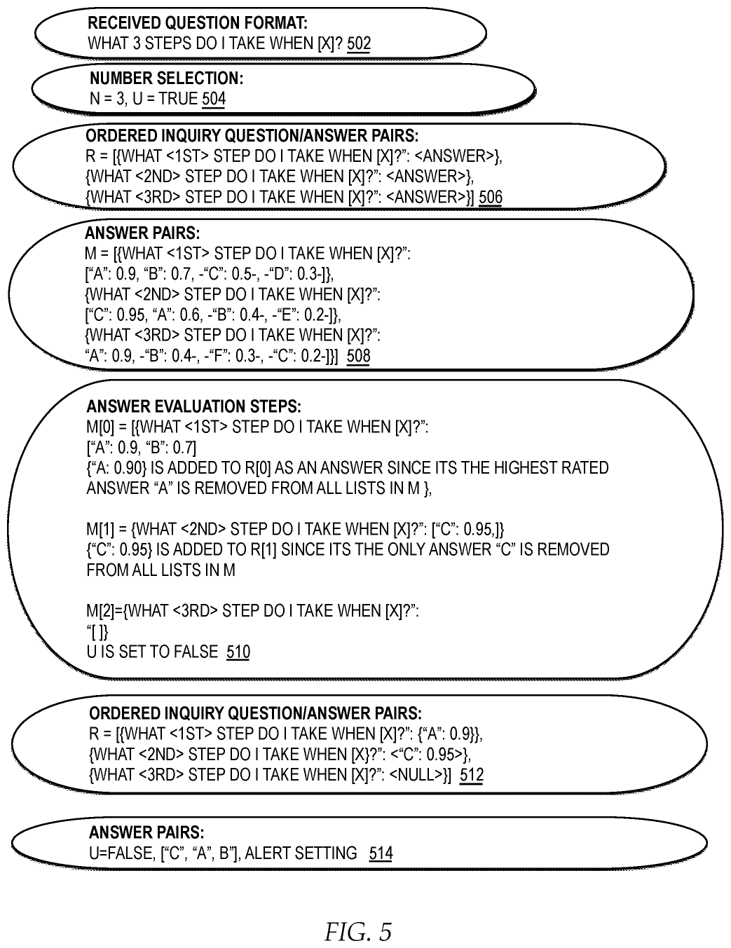

FIG. 5 illustrates a block diagram of an example of a response generated to a multi-facet question requesting an ordered list, with an alert that the ordered list cannot be determined.

In the example, in a similar manner as described with reference to FIG. 4, question analyzer 210 identifies that a received question is in a multi-facet ordered format, such as a question in a format illustrated at reference numeral 502 of “what 3 steps do I take when [X]?”, where “Y” is the “steps” and “X” is a domain of information. In addition, in a similar manner as described with reference to FIG. 5, ordered list controller 240 detects a specified number of answers of “3”, sets “N” to “3” and a variable “U” to true, as illustrated at reference numeral 504, and sets an “R” ordered inquiry question/answer pairs 248 with an array of “N” questions/answer pairs, with each question set to an iteration of a question, and an entry space for an answer pair, as illustrated at reference numeral 506.

In the example, as illustrated at reference numeral 508, ordered list controller 240 separately sends each of the questions in ordered inquiry question/answer pairs 248 to search controller 124 and collects the responses separately received in search answers 128 for each question into a separate entry in “M” answer pairs 250. In the example in FIG. 5, the first two entries illustrated at reference numeral 508 are the same as the first two entries illustrated at reference numeral 408. In FIG. 5, however, as illustrated at reference numeral 508, the third question is paired with an answer of [“A”: 0.9, −“B”: 0.4−, −“F”: 0.3−, −“C”: 0.2−]. In the example, ordered list controller 240 applies ordered confidence threshold 246 set to “0.5” and marks all entries that are not greater than “0.5” with negative marks to indicate the entry is removed.

In the example, as illustrated at reference numeral 510, ordered list controller 240 evaluates each answer pair entry in “M” answer pairs 250 and determines which response to include in “R” ordered inquiry question/answer pairs 248, and evaluates the first entry of “M[0]” and “M[1]” in FIG. 5, in a similar manner as evaluated in FIG. 4. In FIG. 5, however, as illustrated at reference numeral 510, for the third entry in “M[2]”, there are no available responses available because “A” is the only response with a confidence score that exceeds ordered confidence threshold 246, however, “A” is no longer available because it is already the answer set for “R[0]”. In response to detecting that no answer is available that has not already been set as an answer in “R”, ordered list controller 240 sets “U” to false and adds nothing to the answer pair of “R[2]”.

In the example, as illustrated at reference numeral 512, the answer entries of ordered inquiry question/answer pairs 248 are not all updated to include a separate, non-redundant answer, and the variable “U” has been set to false. In the example, as illustrated at reference numeral 514, ordered list controller 240 is not able to generate an ordered list because “U” is set to false, therefore ordered list controller 240 returns top N unique answers by confidence score, which are [“C”, “A”, “B”], and sets alert 254 indicating that an ordered list could not be determined.

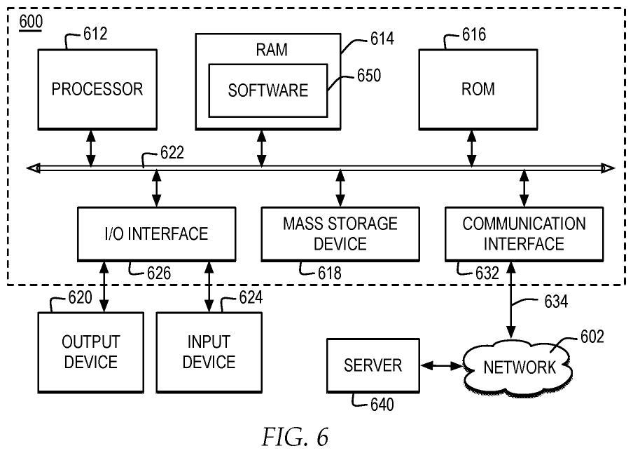

FIG. 6 illustrates a block diagram of one example of a computer system in which one embodiment of the invention may be implemented. The present invention may be performed in a variety of systems and combinations of systems, made up of functional components, such as the functional components described with reference to a computer system 600 and may be communicatively connected to a network, such as network 602.

Computer system 600 includes a bus 622 or other communication device for communicating information within computer system 600, and at least one hardware processing device, such as processor 612, coupled to bus 622 for processing information. Bus 622 preferably includes low-latency and higher latency paths that are connected by bridges and adapters and controlled within computer system 600 by multiple bus controllers. When implemented as a server or node, computer system 600 may include multiple processors designed to improve network servicing power.

Processor 612 may be at least one general-purpose processor that, during normal operation, processes data under the control of software 650, which may include at least one of application software, an operating system, middleware, and other code and computer executable programs accessible from a dynamic storage device such as random access memory (RAM) 614, a static storage device such as Read Only Memory (ROM) 616, a data storage device, such as mass storage device 618, or other data storage medium. Software 650 may include, but is not limited to, code, applications, protocols, interfaces, and processes for controlling one or more systems within a network including, but not limited to, an adapter, a switch, a server, a cluster system, and a grid environment.

Computer system 600 may communicate with a remote computer, such as server 640, or a remote client. In one example, server 640 may be connected to computer system 600 through any type of network, such as network 602, through a communication interface, such as network interface 632, or over a network link that may be connected, for example, to network 602.

In the example, multiple systems within a network environment may be communicatively connected via network 602, which is the medium used to provide communications links between various devices and computer systems communicatively connected. Network 602 may include permanent connections such as wire or fiber optics cables and temporary connections made through telephone connections and wireless transmission connections, for example, and may include routers, switches, gateways and other hardware to enable a communication channel between the systems connected via network 602. Network 602 may represent one or more of packet-switching based networks, telephony-based networks, broadcast television networks, local area and wire area networks, public networks, and restricted networks.

Network 602 and the systems communicatively connected to computer 600 via network 602 may implement one or more layers of one or more types of network protocol stacks which may include one or more of a physical layer, a link layer, a network layer, a transport layer, a presentation layer, and an application layer. For example, network 602 may implement one or more of the Transmission Control Protocol/Internet Protocol (TCP/IP) protocol stack or an Open Systems Interconnection (OSI) protocol stack. In addition, for example, network 602 may represent the worldwide collection of networks and gateways that use the TCP/IP suite of protocols to communicate with one another. Network 602 may implement a secure HTTP protocol layer or other security protocol for securing communications between systems.

In the example, network interface 632 includes an adapter 634 for connecting computer system 600 to network 602 through a link and for communicatively connecting computer system 600 to server 640 or other computing systems via network 602. Although not depicted, network interface 632 may include additional software, such as device drivers, additional hardware and other controllers that enable communication. When implemented as a server, computer system 600 may include multiple communication interfaces accessible via multiple peripheral component interconnect (PCI) bus bridges connected to an input/output controller, for example. In this manner, computer system 600 allows connections to multiple clients via multiple separate ports and each port may also support multiple connections to multiple clients.

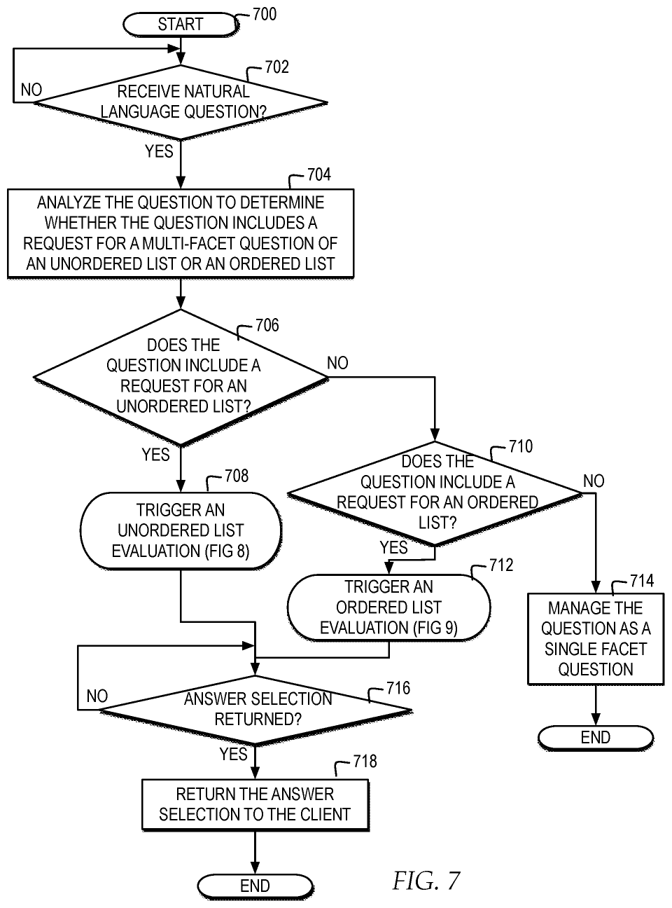

In one embodiment, the operations performed by processor 612 may control the operations of flowchart of FIGS. 7-10 and other operations described herein. Operations performed by processor 612 may be requested by software 650 or other code or the steps of one embodiment of the invention might be performed by specific hardware components that contain hardwired logic for performing the steps, or by any combination of programmed computer components and custom hardware components. In one embodiment, one or more components of computer system 600, or other components, which may be integrated into one or more components of computer system 600, may contain hardwired logic for performing the operations of flowchart in FIGS. 7-10.

In addition, computer system 600 may include multiple peripheral components that facilitate input and output. These peripheral components are connected to multiple controllers, adapters, and expansion slots, such as input/output (I/O) interface 626, coupled to one of the multiple levels of bus 622. For example, input device 624 may include, for example, a microphone, a video capture device, an image scanning system, a keyboard, a mouse, or other input peripheral device, communicatively enabled on bus 622 via I/O interface 626 controlling inputs. In addition, for example, output device 620 communicatively enabled on bus 622 via I/O interface 626 for controlling outputs may include, for example, one or more graphical display devices, audio speakers, and tactile detectable output interfaces, but may also include other output interfaces. In alternate embodiments of the present invention, additional or alternate input and output peripheral components may be added.

With respect to FIG. 6, the present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pukes passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Those of ordinary skill in the art will appreciate that the hardware depicted in FIG. 6 may vary. Furthermore, those of ordinary skill in the art will appreciate that the depicted example is not meant to imply architectural limitations with respect to the present invention.

FIG. 7 illustrates a high-level logic flowchart of a process and computer program for evaluating multi-facet questions and efficiently generating accurate responses to multi-facet questions by a question answering system.

In one example, the process and computer program starts at block 700 and thereafter proceeds to block 702. Block 702 illustrates a determination whether a natural language question is received. At block 702, if a natural language question is received, then the process passes to block 704. Block 704 illustrates analyzing the question to determine whether the question includes a request for a multi-facet question of an unordered list or an ordered list, and the process passes to block 706.

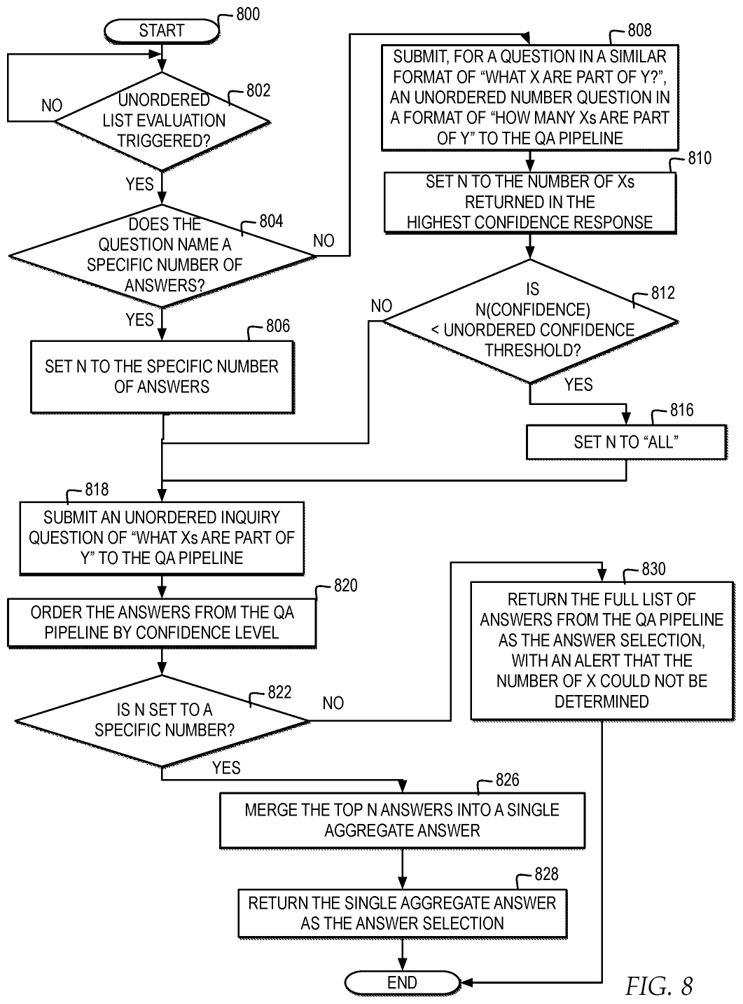

Block 706 illustrates a determination whether the question includes a request for an unordered list. At block 706, if the question includes a request for an unordered list, then the process passes to block 708. Block 708 illustrates triggering an unordered list evaluation, as illustrated in FIG. 8, and the process passes to block 716.

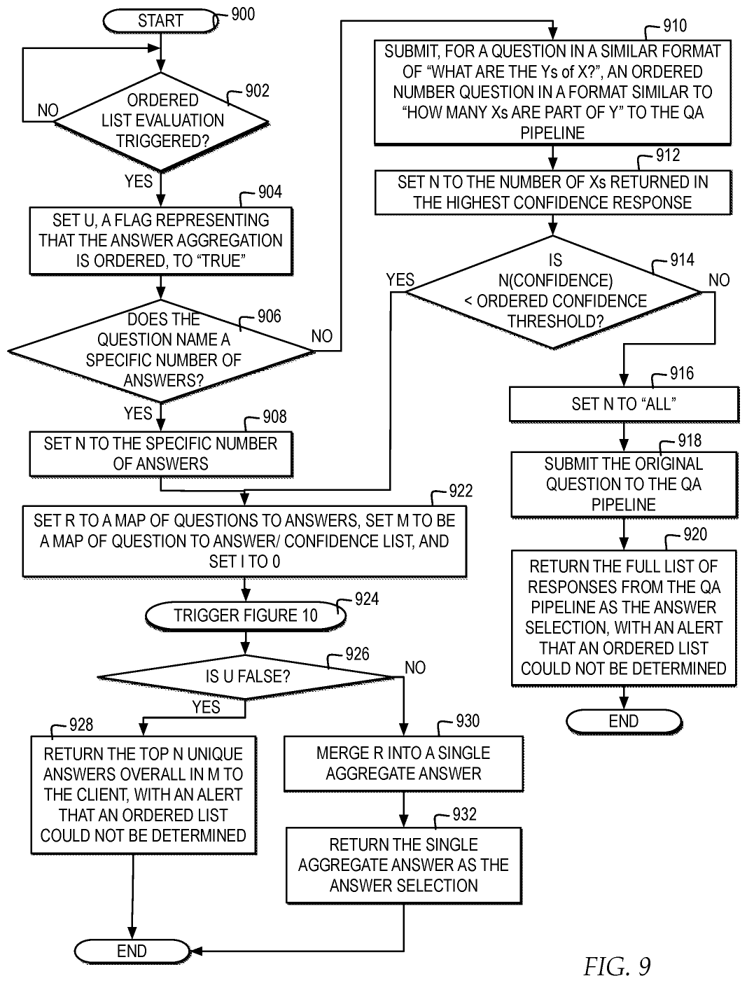

Returning to block 706, if the question does not include a request for an unordered list, then the process passes to block 710. Block 710 illustrates a determination whether the question includes a request for an ordered list. At block 710, if the question includes a request for an ordered list, then the process passes to block 712. Block 712 illustrates triggering an ordered list evaluation, as illustrated in FIG. 9, and the process passes to block 716.

Block 716 illustrates a determination whether an answer selection is returned. At block 716, once an answer selection is returned, then the process passes to block 718. Block 718 illustrates returning the answer selection to the client, and the process ends.

Returning to block 710, if the question does not include a request for an ordered list, then the process passes to block 714. Block 714 illustrates managing the question as a single facet question, and the process ends.

FIG. 8 illustrates a high-level logic flowchart of a process and computer program for efficiently generating accurate responses to a multi-facet question requesting an unordered list from a question answering system.

In one example, the process starts at block 800 and thereafter proceeds to block 802. Block 802 illustrates a determination whether an unordered list evaluation is triggered. At block 802, if an unordered list evaluation is triggered, then the process passes to block 804.

Block 804 illustrates a determination whether the question names a specific number of answers. At block 804, if the question names a specific number of answers, then the process passes to block 806. Block 806 illustrates setting N to the specific number of answers, and the process passes to block 818.

Returning to block 804, if the question does not name a specific number of answers, then the process passes to block 808. Block 808 illustrates submitting, for a question in a similar format of “what X are part of Y”, an unordered number question in a format of “how many Xs are part of Y”, to the QA pipeline. Next, block 810 illustrates setting N to the number of Xs returned in the highest confidence response. Thereafter, block 812 illustrates a determination whether the confidence score of N is less than an unordered confidence threshold. At block 812, if the confidence score of N is not less than an unordered confidence threshold, then the process passes to block 818. Otherwise, at block 812, if the confidence score of N is less than an unordered confidence threshold, then the process passes to block 816. Block 816 illustrates setting N to “all”, and the process passes to block 818.

Block 818 illustrates submitting an unordered inquiry question of “what Xs are part of Y” to the QA pipeline. Next, block 820 illustrates ordering the answers from the QA pipeline by confidence level. Next, block 822 illustrates a determination whether N is set to a specific number. At block 822, if N is not set to a specific number, but is set to “ALL”, the process passes to block 830. Block 830 illustrates returning the full list of answers from the QA pipeline as the answer selection, with an alert that the number of X could not be determined, and the process ends. Returning to block 822, if N is set to a specific number, then the process passes to block 826. Block 826 illustrates merging the top N answers into a single aggregate answer. Next, block 828 illustrates returning the single aggregate answer as the answer selection, and the process ends.

FIG. 9 illustrates a high-level logic flowchart of a process and computer program for efficiently generating accurate responses to a multi-facet question requesting an ordered list from a question answering system.

In one example, the process starts at block 900 and thereafter proceeds to block 902. Block 902 illustrates a determination whether an ordered list evaluation is triggered. At block 902, if an ordered list evaluation is triggered, then the process passes to block 904. Block 904 illustrates setting U, a flag representing that the answer aggregation is ordered, to “true”, and the process passes to block 906.

Block 906 illustrates a determination whether the question names a specific number of answers. At block 906, if the question names a specific number of answers, then the process passes to block 908. Block 908 illustrates setting N to the specific number of answers, and the process passes to block 922. Returning to block 906, if the question does not name a specific number of answers, then the process passes to block 910. Block 910 illustrates submitting, for a question in a similar format of “what are the Ys of X?”, an ordered number question in a format similar to “how many Xs are part of Y” to the QA pipeline. Thereafter, block 912 illustrates setting N to the number of Xs returned in the highest confidence response, and the process passes to block 914.

Block 914 illustrates a determination whether the confidence level of N is less than the ordered confidence threshold. At block 914, if the confidence level of N is less than the ordered confidence threshold, then the process passes to block 922. At block 914, if the confidence level of N is not less than the ordered confidence threshold, then the process passes to block 916. Block 916 illustrates setting N to “all”. Next, block 918 illustrates submitting the original question to the QA pipeline. Thereafter, block 920 illustrates returning the full list of responses from the QA pipeline as the answer selection, with an alert that an ordered list could not be determined, and the process ends.

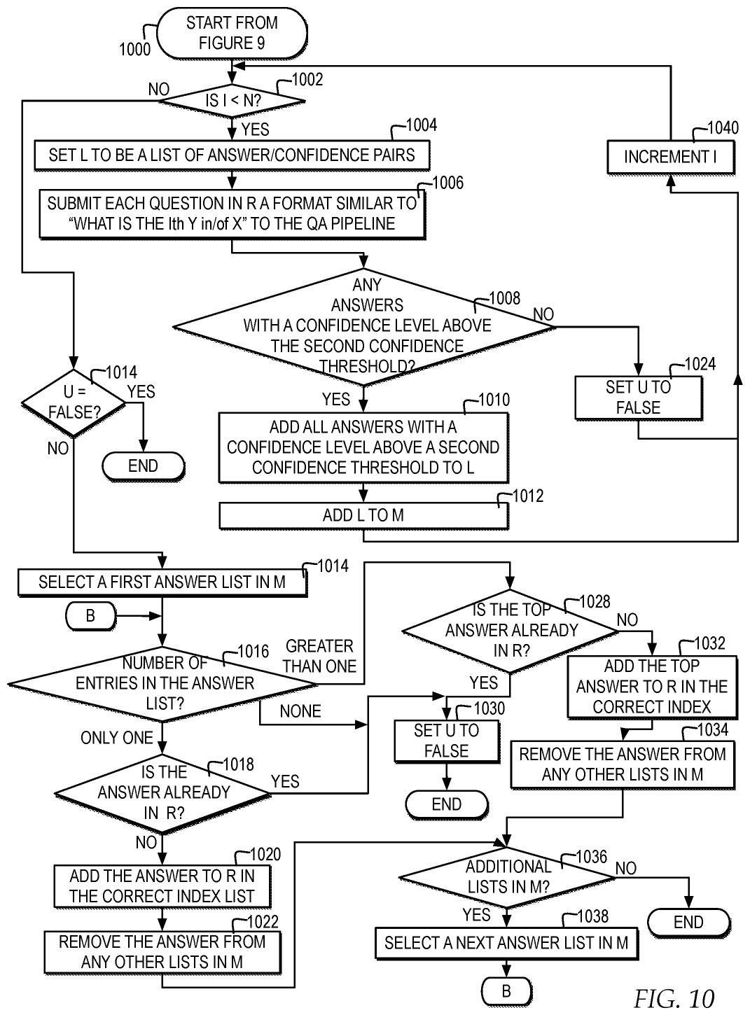

Returning to block 922, block 922 illustrates setting R, which represents to ordered inquiry answer/question pairs, to a map of questions to answers, setting M to a map of answers pairs in an answer/confidence list, and setting I to “0”. Next, block 924 illustrates triggering FIG. 10. When the process returns to FIG. 9, block 926 illustrates a determination whether U is false. At block 926, if U is false, then the process passes to block 928. Block 928 illustrates returning the top N unique answers overall in M to the client, with an alert that an ordered list could not be determined, and the process ends. Returning to block 926, at block 926, if U is not false, then the process passes to block 930. Block 930 illustrates merging R into a single aggregate answer. Next, block 932 illustrates returning the single aggregate answer as the answer selection, and the process ends.

FIG. 10 illustrates a high-level logic flowchart of a process and computer program for identifying a particular selection of responses to a multi-facet question requesting an ordered list by a question answering system.

In one example, the process and program starts at block 1000, when triggered from FIG. 9, and thereafter proceeds to block 1002. At block 1002, if I is less than N, then the process passes to block 1004. Block 1004 illustrates setting L to be at list of answer/confidence pairs. Next, block 1006 illustrates iteratively submitting each of the questions in R, in a format similar to “what is the Ith Y in/of X?”, to the QA pipeline, and the process passes to block 1008. Block 1008 illustrates a determination whether any answers with a confidence level above a second confidence threshold are received. At block 1008, if there are not any answers with a confidence level above a second confidence threshold, then the process passes to block 1024. Block 1024 illustrates setting U to false. Next, block 1040 illustrates incrementing I, and the process returns to block 1002.

Returning to block 1008, at block 1008, if there are any answers with a confidence level above a second confidence threshold, then the process passes to block 1010. Block 1010 illustrates adding all answers with a confidence level above a second confidence threshold to L. Next, block 1012 illustrates adding L to M, and the process passes to block 1040.

Returning to block 1002, if I is not less than N, then the process passes to block 1013. Block 1013 illustrates a determination whether U is set to false. At block 1013, if U is set to false, then the process ends. Otherwise, at block 1013, if U is not set to false, the process passes to block 1014.

Block 1014 illustrates selecting a first answer list in M. Next, block 1016 illustrates a determination of what number of entries is present in the answer list. At block 1016, if the number of entries in the answer list is none, then the process passes to block 1030. Block 1030 illustrates setting U to false, and the process ends.

Returning to block 1016, if the number of entries in the answer list is only one, then the process passes to block 1018. Block 1018 illustrates a determination whether the answer is already in R. At block 1018, if the answer is already in R, then the process passes to block 1030. Otherwise at block 1018, if the answer is not already in R, then the process passes to block 1020. Block 1020 illustrates adding the answer to R in the correct index list. Next, block 1022 illustrates removing the answer from any other lists in M, and the process passes to block 1036.

Returning to block 1016, if the number of entries in the answer list is greater than one, then the process passes to block 1028. Block 1028 illustrates a determination whether the top answer is already in R. At block 1028, if the top answer is not already in R, then the process passes to block 1032. Block 1032 illustrates adding the top answer to R in the correct index. Next, block 1034 illustrates removing the answer from any other lists in M, and the process passes to block 1036. Returning to block 1028, if the top answer is already in R, then the process passes to block 1030, which, as previously described sets U to false and proceeds to block 1036.

Block 1036 illustrates a determination whether there are additional lists in M. At block 1036, if there are additional lists in M, then the process passes to block 1038. Block 1038 illustrates selecting a next answer list in M, and the process returns to block 1016. Returning to block 1036, if there are not additional lists in M, then the process ends and returns to block 924 of FIG. 9.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising”, when used in this specification specify the presence of stated features, integers, steps, operations, elements, and/or components, but not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the one or more embodiments of the invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

While the invention has been particularly shown and described with reference to one or more embodiments, it will be understood by those skilled in the art that various changes in form and detail may be made therein without departing from the spirit and scope of the invention.

What is claimed is:

1. A method comprising:
responsive to receiving a multi-facet natural language question from a user at a question answering system, generating, by a computer, one or more inquiry questions to submit to the question answering system for an order type requirement of the multi-facet natural language question;
evaluating, by the computer, a plurality of responses, each with a respective confidence score by the question answering system, to each of the one or more inquiry questions to identify a selection of answers from among the plurality of responses, the selection of answers capped at a number of specific answers assessed for the multi-facet natural language question; and
merging, by the computer, the selection of answers into a single aggregated answer to return to the user in response to the multi-facet natural language question.

2. The method according to claim 1, further comprising:
responsive to receiving the multi-facet natural language question, evaluating, by the computer, whether the multi-facet natural language question specifies a particular number in the question content;
responsive to the multi-facet natural language question specifying a particular number in the question content, setting, by the computer, the number of specific answers at the particular number;
responsive to the multi-facet natural language question not specifying a particular number in the question content, generating, by the computer, a number question from the multi-facet natural language question to request a quantity associated with the multi-facet natural language question;
submitting, by the computer, the number question to the question answering system;
responsive to at least one of a second selection of responses to the number question having a separate confidence score exceeding a confidence threshold, setting, by the computer, the number of specific answers to a particular response of the second selection of responses with a highest confidence score exceeding the confidence threshold; and
responsive to none of a second selection of responses to the number question having a separate confidence score exceeding a confidence threshold, setting, by the computer, the number of specific answers to all.

3. The method according to claim 2, further comprising:
responsive to the number of specific answers set to all, returning, by the computer, the plurality of responses to the user.

4. The method according to claim 1, wherein responsive to receiving the multi-facet natural language question from the user at the question answering system, generating, by the computer, the one or more inquiry questions to submit to the question answering system for the order type requirement of the multi-facet natural language question further comprises:
analyzing, by the computer, the multi-facet natural language question to determine the one or more characteristics of the multi-facet natural language question include the question requesting the multi-facet answer.

5. The method according to claim 4, further comprising:
evaluating, by the computer, whether the multi-facet answer requires sequentially classifying the selection of answers in the ordered list;
responsive to detecting the multi-facet answer requires sequentially classifying the selection of answers in the ordered list, generating, by the computer, the one or more inquiry questions comprising a plurality of questions each based on a separate iteration of the multi-facet natural language question, where a number of iterations is set to the number of specific answers; and
responsive to detecting the multi-facet answer only requires an unordered list, generating, by the computer, the one or more inquiry questions as a single inquiry question based on the multi-facet natural language question.

6. The method according to claim 5, further comprising:
responsive to receiving a separate selection of responses to each separate iteration, removing, by the computer, from each separate selection of responses any particular response with a respective confidence score that is less than a confidence threshold;
responsive to a first separate selection of responses comprising a first top response, adding, by the computer, the first top response to a first entry in a selection of question and answer pairs and removing the first top response from each remaining separate selection of responses;
responsive to the first separate selection of responses not comprising a first top response, setting, by the computer, an indicator that that the ordered list cannot be determined;
responsive to each next separate selection of responses comprising a next top response, adding, by the computer, the next top response to a next entry in the selection of question and answer pairs and removing the next top response from each remaining separate selection of responses;
responsive to one or more of each next separate selection of responses not comprising a next top response, setting, by the computer, the indicator that that the ordered list cannot be determined;
responsive to the indicator that the ordered list cannot be determined being set, returning, by the computer, to the user, the selection of answers comprising the top scoring independent responses from each separate selection of responses to each separate iteration; and
responsive to the indicator that the order list cannot be determined not being set, merging, by the computer, a plurality of answer entries in the selection of question and answer pairs as the selection of answers into the single aggregated answer.

7. The method according to claim 1, further comprising:
submitting, by the computer, the one or more inquiry questions to one or more data objects trained in a natural language processing environment based on a corpus of a plurality of files.

8. A computer system comprising one or more processors, one or more computer-readable memories, one or more computer-readable storage devices, and program instructions, stored on at least one of the one or more storage devices for execution by at least one of the one or more processors via at least one of the one or more memories, the stored program instructions comprising:
program instructions, responsive to receiving a multi-facet natural language question from a user at a question answering system, to generate one or more inquiry questions to submit to the question answering system for an order type requirement of the multi-facet natural language question;
program instructions to evaluate a plurality of responses, each with a respective confidence score by the question answering system, to each of the one or more inquiry questions to identify a selection of answers from among the plurality of responses, the selection of answers capped at a number of specific answers assessed for the multi-facet natural language question; and
program instructions to merge the selection of answers into a single aggregated answer to return to the user in response to the multi-facet natural language question.

9. The computer system according to claim 8, further comprising:
program instructions, responsive to receiving the multi-facet natural language question, to evaluate whether the multi-facet natural language question specifies a particular number in the question content;
program instructions, responsive to the multi-facet natural language question specifying a particular number in the question content, to set the number of specific answers at the particular number;
program instructions, responsive to the multi-facet natural language question not specifying a particular number in the question content, to generate a number question from the multi-facet natural language question to request a quantity associated with the multi-facet natural language question;
program instructions to submit the number question to the question answering system;
program instructions, responsive to at least one of a second selection of responses to the number question having a separate confidence score exceeding a confidence threshold, to set the number of specific answers to a particular response of the second selection of responses with a highest confidence score exceeding the confidence threshold; and
program instructions, responsive to none of a second selection of responses to the number question having a separate confidence score exceeding a confidence threshold, to set the number of specific answers to all.

10. The computer system according to claim 9, further comprising:
program instructions, responsive to the number of specific answers set to all, to return the plurality of responses to the user.

11. The computer system according to claim 8, wherein the program instructions, responsive to receiving the multi-facet natural language question from the user at the question answering system, to generate the one or more inquiry questions to submit to the question answering system for the order type requirement of the multi-facet natural language question further comprises:
program instructions to analyze the multi-facet natural language question to determine one or more characteristics of the multi-facet natural language question include a question requesting a multi-facet answer.

12. The computer system according to claim 11, further comprising:
program instructions to evaluate whether the multi-facet answer requires sequentially classifying the selection of answers in an ordered list;
program instructions, responsive to detecting the multi-facet answer requires sequentially classifying the selection of answers in the ordered list, to generate the one or more inquiry questions comprising a plurality of questions each based on a separate iteration of the multi-facet natural language question, where a number of iterations is set to the number of specific answers; and
program instructions, responsive to detecting the multi-facet answer only requires an unordered list, to generate the one or more inquiry questions as a single inquiry question based on the multi-facet natural language question.

13. The computer system according to claim 12, further comprising:
program instructions, responsive to receiving a separate selection of responses to each separate iteration, to remove from each separate selection of responses any particular response with a respective confidence score that is less than a confidence threshold;
program instructions, responsive to a first separate selection of responses comprising a first top response, to add first top response to a first entry in a selection of question and answer pairs and removing the first top response from each remaining separate selection of responses;
program instructions, responsive to the first separate selection of responses not comprising a first top response, to set an indicator that that the ordered list cannot be determined;
program instructions, responsive to each next separate selection of responses comprising a next top response, to add the next top response to a next entry in the selection of question and answer pairs and removing the next top response from each remaining separate selection of responses;
program instructions, responsive to one or more of each next separate selection of responses not comprising a next top response, to set the indicator that that the ordered list cannot be determined;
program instructions, responsive to the indicator that the ordered list cannot be determined being set, to return to the user the selection of answers comprising the top scoring independent responses from each separate selection of responses to each separate iteration; and
program instructions, responsive to the indicator that the order list cannot be determined not being set, to merge a plurality of answer entries in the selection of question and answer pairs as the selection of answers into the single aggregated answer.

14. The computer system according to claim 8, further comprising:
program instructions to submit the one or more inquiry questions to one or more data objects trained in a natural language processing environment based on a corpus of a plurality of files.

15. A computer program product comprises one or more computer readable storage media having program instructions collectively stored thereon, wherein the one or more computer readable storage media are not a transitory signal per se, the program instructions executable by a computer to cause the computer to:
responsive to receiving a multi-facet natural language question from a user at a question answering system, generate, by a computer, one or more inquiry questions to submit to the question answering system for an order type requirement of the multi-facet natural language question;
evaluate, by the computer, a plurality of responses, each with a respective confidence score by the question answering system, to each of the one or more inquiry questions to identify a selection of answers from among the plurality of responses, the selection of answers capped at a number of specific answers assessed for the multi-facet natural language question; and
merge, by the computer, the selection of answers into a single aggregated answer to return to the user in response to the multi-facet natural language question.

16. The computer program product according to claim 15, further comprising the program instructions executable by a computer to cause the computer to:
responsive to receiving the multi-facet natural language question, evaluate, by the computer, whether the multi-facet natural language question specifies a particular number in the question content;
responsive to the multi-facet natural language question specifying a particular number in the question content, set, by the computer, the number of specific answers at the particular number;
responsive to the multi-facet natural language question not specifying a particular number in the question content, generate, by the computer, a number question from the multi-facet natural language question to request a quantity associated with the multi-facet natural language question;
submit, by the computer, the number question to the question answering system;
responsive to at least one of a second selection of responses to the number question having a separate confidence score exceeding a confidence threshold, set, by the computer, the number of specific answers to a particular response of the second selection of responses with a highest confidence score exceeding the confidence threshold; and
responsive to none of a second selection of responses to the number question having a separate confidence score exceeding a confidence threshold, set, by the computer, the number of specific answers to all.

17. The computer program product according to claim 16, further comprising the program instructions executable by a computer to cause the computer to:
responsive to the number of specific answers set to all, return, by the computer, the plurality of responses to the user.

18. The computer program product according to claim 15, further comprising the program instructions executable by a computer to cause the computer to:
analyze, by the computer, the multi-facet natural language question to determine the one or more characteristics of the multi-facet natural language question include the question requesting the multi-facet answer.

19. The computer program product according to claim 18, further comprising the program instructions executable by a computer to cause the computer to:
evaluate, by the computer, whether the multi-facet answer requires sequentially classifying the selection of answers in the ordered list;
responsive to detecting the multi-facet answer requires sequentially classifying the selection of answers in the ordered list, generate, by the computer, the one or more inquiry questions comprising a plurality of questions each based on a separate iteration of the multi-facet natural language question, where a number of iterations is set to the number of specific answers; and
responsive to detecting the multi-facet answer only requires an unordered list, generate, by the computer, the one or more inquiry questions as a single inquiry question based on the multi-facet natural language question.

20. The computer program product according to claim 19, further comprising the program instructions executable by a computer to cause the computer to:
responsive to receiving a separate selection of responses to each separate iteration, remove, by the computer, from each separate selection of responses any particular response with a respective confidence score that is less than a confidence threshold;
responsive to a first separate selection of responses comprising a first top response, add, by the computer, the first top response to a first entry in a selection of question and answer pairs and removing the first top response from each remaining separate selection of responses;
responsive to the first separate selection of responses not comprising a first top response, set, by the computer, an indicator that that the ordered list cannot be determined;
responsive to each next separate selection of responses comprising a next top response, add, by the computer, the next top response to a next entry in the selection of question and answer pairs and removing the next top response from each remaining separate selection of responses;
responsive to one or more of each next separate selection of responses not comprising a next top response, set, by the computer, the indicator that that the ordered list cannot be determined;
responsive to the indicator that the ordered list cannot be determined being set, return, by the computer, to the user, the selection of answers comprising the top scoring independent responses from each separate selection of responses to each separate iteration; and
responsive to the indicator that the order list cannot be determined not being set, merge, by the computer, a plurality of answer entries in the selection of question and answer pairs as the selection of answers into the single aggregated answer.
